(19) United States
(12) Patent Application Publication
(10) Pub. No.: US 2014/0135439 A1
(43) Pub. Date: May 15, 2014

(54) POLYMER-ENCAPSULATED NON-PIGMENT PARTICLES

(71) Applicants: John Klier Midland, Maple Glen, MI (US); Dan A. Bors, Maple Glen, PA (US)

(72) Inventors: John Klier Midland, Maple Glen, MI (US); Dan A. Bors, Maple Glen, PA (US)

(21) Appl. No.: 14/232,925

(22) PCT Filed: Jul. 18, 2012
(86) PCT No.: PCT/US12/47115

§ 371 Date: Jan. 15, 2014

Related U.S. Application Data
(60) Provisional application No. 61/512,449, filed on Jul. 28, 2011.

(51) Int. Cl. C08L 57/06; C08J 3/21; C08L 57/12

(52) U.S. Cl. CPC C08L 57/06; C08L 57/12; C08J 3/21
USPC 524/430; 524/521; 524/493

(57) ABSTRACT

A non-pigment particle that includes a non-pigment inorganic particle having an average particle diameter of from 0.005 to 5 microns and an index of refraction of less than 1.8, a water-soluble sulfur acid-functional first polymer and a second polymer that at least partially encapsulates the non-pigment inorganic particle.

This invention relates to a non-pigment particle encapsulated in polymer.

Opacifying pigment particles encapsulated with polymer are disclosed in U.S. Pub. App. No. 2010/0298483. However, this reference does not disclose or suggest other types of encapsulated particles.

The problem addressed by this invention is the need for additional materials useful for coatings.

### STATEMENT OF THE INVENTION

The present invention is directed to a non-pigment particle encapsulated in polymer. The encapsulated particle comprises: (a) a non-pigment inorganic particle having an average particle diameter of from 0.1 to 5 microns and an index of refraction of less than 1.8; (b) from 0.1 to 25 wt % of a water-soluble sulfur acid-functional first polymer, based on the weight of the non-pigment inorganic particle; and (c) from 10 to 200 wt % of a second polymer that at least partially encapsulates the non-pigment inorganic particle, based on the weight of the non-pigment inorganic particle. The invention is further directed to a process for forming the non-pigment particle encapsulated in polymer and compositions including the non-pigment particle encapsulated in polymer.

### DETAILED DESCRIPTION OF THE INVENTION

All percentages are by weight (wt %) and all temperatures are in ° C., unless specified otherwise. For the purposes of this invention, “inorganic” refers to materials substantially free of carbon, with the exception of carbon in the form of carbonates.

Certain sulfur acid-functional polymers, when used as dispersants for certain inorganic non-pigment particles, provide for the encapsulation of the non-pigment inorganic particles via a viable emulsion polymerization process. The non-pigment particle encapsulated in polymer provides desirably high hiding efficiency and is capable of being formed in an aqueous medium with low grit levels.

The present invention provides a process for forming a non-pigment particle encapsulated in polymer; said process comprising steps of: (a) dispersing a non-pigment inorganic particle having an average particle diameter of from 0.005 to 5 microns and an index of refraction of less than 1.8 in a medium with from 0.1 to 25 wt % of a water-soluble sulfur acid-functional first polymer, based on the weight of said non-pigment inorganic particle; and (b) performing an emulsion polymerization in the presence of said non-pigment inorganic particle to provide from 10 to 200 wt % of a second polymer that at least partially encapsulates said non-pigment inorganic particle, based on the weight of said non-pigment inorganic particle.

The present invention relates to a non-pigment inorganic particle encapsulated in polymer. The non-pigment inorganic particle has an average particle diameter of from 0.005 to 5 microns and an index of refraction [n_{D} (20° C.)] of less than 1.8, preferably less than 1.7, preferably less than 1.6, preferably less than 1.5, preferably less than 1.4, preferably less than 1.3. The shape of the non-pigment inorganic particles is not important. Suitable shapes for the non-pigment inorganic particles include spherical shapes, such as a regular sphere, an oblate sphere, a prolate sphere, and an irregular sphere; cubic shapes such as a regular cube and a rhombus; plate-like shapes including a flat plate, a concave plate, and a convex plate; and irregular shapes. The non-pigment inorganic particles having spherical shapes have average diameters in the range of from 100 nm to 10 micron, preferably in the range of from 150 nm to 5 micron, and more preferably, in the range of from 200 nm to 1 micron. Non-pigment inorganic particles having nonspherical shapes preferably have average diameters, defined as their maximum dimension, of from 5 nm to 5 micron, more preferably of from 150 nm to 500 nm, and most preferably of from 200 nm to 350 nm The average diameters of pigment particles are typically provided by pigment particle suppliers.

Suitable non-pigment inorganic particles include calcium carbonate (natural and precipitated), talc, feldspar, barium sulfate, clay (natural, delaminated, calcined), aluminum metal, alumina, silver metal, silver oxide, silica, mica, magnesium carbonate and zirconia. Preferably, the non-pigment inorganic particles are selected from alumina and silica, preferably alumina.

The non-pigment inorganic particles may have a uniform composition or a heterogeneous composition with two or more phases. Certain heterogeneous non-pigment inorganic particles have an inner core and surrounding shell structure wherein one type of non-pigment inorganic particle forms the core and another type of particle forms the shell. The core and shell heterogeneous non-pigment inorganic particles include core/shell particles having a shell completely or incompletely encapsulating the core; core/shell particles having more than one core; dipolar particles; and particles having multiple domains of one phase on the surface of the other phase. Non-pigment inorganic particles can have at least one coating of one or more of silica, alumina, zinc oxide, and zirconia; preferably one or more of silica and alumina; preferably alumina.

Preferably, the non-pigment inorganic particles encapsulated in polymer include from 0.1 to 25 wt % of water-soluble sulfur acid-functional first polymer, preferably from 0.25 to 10 wt %, preferably from 0.5 to 5 wt %, preferably from 0.5 to 2 wt %, based on the weight of the non-pigment inorganic particle. Typically the non-pigment inorganic particles have been dispersed in a medium, preferably an aqueous medium, with the water-soluble sulfur acid-functional first polymer. By “aqueous medium” herein is meant water and from 0 to 30 wt % based on the weight of the aqueous medium, of water-miscible compound(s). “Sulfur acid-functional polymer” herein includes any water-soluble polymer including at least three sulfur acid moieties. As used herein, the term “sulfur acid-functional monomer” is meant to include any monomer containing at least one free radical polymerizable vinyl group, and at least one sulfur acid moiety. As used herein, the term “sulfur acid moiety” is meant to include any of the following residues: —S(O)₂(OH), —OS(O)₂(OH), —OS(O)(OH), —S(O)(OH). Also included in the definition of term “sulfur acid moiety” are salts of the above residues. As used herein, the term “water-soluble sulfur acid-functional first polymer” means that the sulfur acid-functional first polymer is soluble in water at 25° C. at a pH of less than or equal to 5 to an extent of at least 5% by weight.

The sulfur acid-functional first polymer can be any of a polymer with at least three sulfur acid moieties located randomly in the polymer backbone, a block copolymer with a single sulfur acid-including block and at least one block which does not have sulfur acids, or a comb-graft polymer with a backbone that includes sulfur acids and teeth which do not include sulfur acids. The block copolymers can have the sulfur acid-including block located terminal to the polymer, or within the interior of the polymer chain. In a preferred embodiment of the present invention, the sulfur acid-functional polymer contains both sulfur acid and amine moieties. In this preferred embodiment of the present invention, it is further preferred that the polymer have at least two amine and three sulfur acid groups, it is more preferred that the polymer have at least three amine and five sulfur acid groups, it is most preferred that the polymer have at least four amine and eight sulfur acid groups. The number of amine and sulfur acid groups may be the same or different. It is preferred that the ratio of amine to sulfur acid groups be between 10:1 and 1:10, more preferred that the ratio of amine to sulfur acid groups be between 3:1 and 1:4, most preferred that the ratio of amine to sulfur acid groups be between 1.5:1 and 1:3, on a molar basis. The sulfur acid-functional polymer may be made as a solution polymer in water or a non-aqueous solvent, or as a bulk polymer. The sulfur acid-functional polymer may be made by any suitable polymerization process, such as addition polymerization of ethylenically unsaturated monomers such as acrylic, styrenic, or vinyl monomers. Polymers that contain both amine and sulfur acid groups may be made by copolymerizing at least one amine-functional monomer and at least one sulfur acid-functional monomer, or they may be made by including at least one monomer which is both amine-functional and sulfur acid-functional in the monomer mix. As a further example, polymers that include both amine and sulfur acid groups may be made by the addition polymerization of ethylenically unsaturated monomers, including in the monomer mix functional monomers that can be converted to amine or sulfur acid groups after the polymerization is completed. Examples of monomers that can be converted to amines after the polymerization is completed include isocyanate-functional monomers, which can be reacted with primary-tertiary or secondary-tertiary diamines, epoxy-functional monomers that can be reacted with amines, and halomethylbenzyl-functional monomers that can be reacted with amines. Examples of monomers that can be converted to sulfur acids after the polymerization is completed include isocyanate-functional monomers, which can be reacted with aminosulfates. Block copolymers that include a sulfur acid-functional polymer-including block may be made by any known process that is capable of producing such polymers. For example, block copolymers that include a sulfur acid-functional polymer-including block may be made by the living free radical polymerization of ethylenically unsaturated monomers wherein the monomer composition of one of the monomer feeds includes at least one sulfur acid-functional unsaturated monomer. As a further example, block copolymers that include a sulfur acid-functional polymer-including block may be made by the living free radical polymerization of ethylenically unsaturated monomers, including in the monomer mix functional monomers that can be converted to sulfur acid groups after the polymerization is completed. Comb-graft polymers that include a sulfur acid-functional polymer-including backbone may be made by any known process that is capable of producing such polymers. For example, comb-graft polymers that include a sulfur acid-functional polymer-including backbone may be made by the free radical polymerization of ethylenically unsaturated monomers wherein the monomer composition includes at least unsaturated macromer and at least one sulfur acid-functional unsaturated monomer. As a further example, comb-graft polymers that include a sulfur acid-functional polymer-including backbone may be made by the living free radical polymerization of ethylenically unsaturated monomers, including in the monomer mix functional monomers that can be converted to sulfur acid groups after the polymerization is completed. It is preferred that the sulfur acid-functional polymer be a linear random copolymer.

The sulfur acid-functional polymer is typically prepared by the addition polymerization of ethylenically unsaturated monomers. Suitable monomers include styrene, butadiene, alpha-methyl styrene, vinyl toluene, vinyl naphthalene, ethylene, propylene, vinyl acetate, vinyl versatate, vinyl chloride, vinylidene chloride, acrylonitrile, methacrylonitrile, (meth)acrylamide, various C₁-C₄₀ alkyl esters of (meth)acrylic acid; other (meth) acrylates such as isobornyl (meth)acrylate, benzyl (meth)acrylate, phenyl (meth)acrylate, 2-bromoethyl (meth)acrylate, 2-phenylethyl (meth)acrylate, and 1-naphthyl (meth)acrylate, alkoxyalkyl (meth)acrylates, such as ethoxyethyl (meth)acrylate, mono-, di-, trialkyl esters of ethylenically unsaturated di- and tricarboxylic acids and anhydrides, such as ethyl maleate, dimethyl fumarate, trimethyl aconitate, and ethyl methyl itaconate; hydroxyalkyl (meth)acrylates; carboxylic acid containing monomers, such as (meth)acrylic acid, itaconic acid, fumaric acid, and maleic acid. Examples of suitable sulfur acid-functional monomers include sulfoethyl (meth)acrylate, sulfopropyl (meth)acrylate, styrene sulfonic acid, vinyl sulfonic acid, and 2-(meth)acrylamido-2-methyl propanesulfonic acid, and salts there of. Examples of suitable amine-functional monomers include dimethylamino ethyl(meth)acrylate, dimethylamino propyl(meth)acrylamide, and t-butylamino ethyl(meth)acrylate. As used herein, the term “(meth)acrylate” refers to either acrylate or methacrylate and the term “(meth)acrylic” refers to either acrylic or methacrylic.

The sulfur acid-functional polymer random copolymer, sulfur acid including block of the block copolymer, or sulfur acid including backbone of the comb-graft polymer may have a weight average molecular weight of 1000 to 200,000, preferably from 1000 to 50,000, more preferably from 2000 to 15,000, and most preferably from 3000 to 10,000. When the sulfur acid-functional polymer is a block copolymer or a comb-graft polymer, the non-sulfur acid including block(s) or teeth, respectively, may have a weight average molecular weight of 750 to 200,000, more preferably from 1000 to 50,000, more preferably form 1500 to 25,000, and most preferably from 5000 to 15,000. The molecular weights may be determined by GPC.

Preferably, the non-pigment inorganic particles are dispersed in an aqueous medium with the water-soluble sulfur acid-functional polymer. The sulfur acid-functional polymer can be made water-soluble by the inclusion of sufficient amine and or sulfur acid groups, as well as by including sufficient levels of copolymerized water-soluble monomers such as alcohol-functional monomers such as hydroxyethyl (meth)acrylate; amide-functional monomers such as (meth)acrylamide; acid-functional monomers such as (meth)acrylic acid; or combinations thereof. The levels of water-soluble monomers necessary to render the sulfur acid-functional polymer or polymer block or teeth water-soluble will depend on the molecular weight and nature of the co-monomers included in the composition of the sulfur acid-functional polymer, blocks, or teeth, as is known in the art. When the sulfur acid-functional polymer is a block copolymer or a comb-graph polymer, it is preferred that the non-sulfur acid block(s) or teeth, respectively, be in themselves water-soluble.

The non-pigment inorganic particle encapsulated in polymer of the present invention includes from 10 to 200 wt % of a second polymer that at least partially encapsulates the non-pigment inorganic particle, based on the weight of the non-pigment inorganic particle. The second polymer is typically prepared by free radical emulsion polymerization of ethylenically unsaturated monomers in the presence of the non-pigment inorganic particle that has been dispersed in a medium. In some embodiments the second polymer is made of a monomer mixture containing at least one water-soluble monomer. Examples of suitable water soluble monomers are acid functional monomers like 2-sulfoethyl (meth)acrylate, sulfopropyl (meth)acrylate, styrene sulfonic acid, vinyl sulfonic acid, 2-(meth)acrylamido-2-methyl propanesulfonic acid, acrylic acid, methacrylic acid, itaconic acid and the salts thereof. Other suitable water soluble monomers are acrylamide, diacetoneacrylamide, 2-hydroxyethyl methacrylate and 2-hydroxyethyl acrylate.

By “at least partially encapsulated” herein is meant that the second polymer is in contact with at least a part of the surface of the non-pigment inorganic particle. The degree of encapsulation of the non-pigment inorganic particle may be determined using an electron micrograph. Determination of the degree of encapsulation does not include any contribution of first polymer, surfactant, dispersant, or the like. By “X % encapsulated” herein is meant that X % of the surface area of the non-pigment inorganic particle is in contact with the second polymer; preferably greater than 50%, more preferably greater than 75%, and most preferably 100% of the surface area of the particle is in contact with the second polymer. The thickness of the second polymer encapsulant layer or shell may be up to 500 nm; preferably the thickness of the second polymer encapsulant layer or shell is between 20 nm and 150 nm, preferably from 40 nm to 100 nm.

Preferably, the non-pigment inorganic particle encapsulated in polymer is formed by a process which includes: (a) dispersing a non-pigment inorganic particle having an average particle diameter of from 0.005 to 5 microns and an index of refraction less than 1.8 in a medium with from 0.1% to 25% by weight, based on the weight of the non-pigment inorganic particle, water-soluble sulfur acid-functional first polymer; and (b) performing an emulsion polymerization in the presence of the dispersed non-pigment inorganic particle to provide from 10% to 200%, by weight, based on the weight of the pigment particle, second polymer that at least partially encapsulates said dispersed non-pigment inorganic particle.

A step in this process of the present invention consists of dispersing non-pigment inorganic particles in a medium, preferably an aqueous medium, with a water-soluble sulfur acid-functional polymer. This dispersion step may be effected by any means commonly used to disperse insoluble solids in an aqueous medium, including, for example, grinding with a high speed dispersator, or grinding in media mills or ball mills. The weight of the water-soluble sulfur acid-functional polymer based on the weight of the non-pigment inorganic particles can range from 0.1% to 25%, preferably from 0.25% to 10%, more preferably from 0.5% to 5%, and most preferably from 0.5% to 2%.

In any event the non-pigment dispersion must have sufficient stability during storage (substantially maintaining the same particle size, no or minimal sediment formation) and must have sufficient stability to withstand flocculation during the second polymer encapsulation process. During the initial stages of the encapsulation process the stabilization mechanism will typically change from a dispersant-stabilized particle surface at a first pH to a surfactant-stabilized polymer surface at a lower pH. It is believed that while this change is taking place there will inevitably be an interval in which the stabilization by the dispersant is reduced and if the stabilization gets too weak then flocculation of inorganic particles will occur.

A step in the process of the present invention includes at least partially encapsulating the dispersed non-pigment inorganic particles with from 10 to 200 wt % of a second polymer, based on the weight of the pigment particle, by performing an emulsion polymerization in the presence of the dispersed non-pigment inorganic particles. Alternatively, it is contemplated that the dispersion of polymer particles may be dried or partially dried and redispersed in an aqueous medium prior to encapsulation.

The emulsion polymerization can be carried out by methods well known in the polymer art, and includes multiple stage polymerization processes. Various synthesis adjuvants such as initiators, chain transfer agents, and surfactants are optionally utilized in the polymerization. In general, the emulsion polymerization is of a seeded type emulsion polymerization, with the dispersed non-pigment inorganic particles acting as the seeds. In one preferred embodiment of the present invention, the reaction vessel is charged with water, dispersed non-pigment inorganic particles, and optionally surfactants and other polymerization adjuvants, and then the monomers for the second polymer are added to the kettle. In another preferred embodiment of the present invention, the reaction vessel is charged with water, dispersed non-pigment inorganic particles, and optionally surfactants and other polymerization adjuvants, and then a part of the monomers for the polymer matrix is added to the kettle, and then a seed consisting of emulsified polymer particles, made separately, is added, and finally the remainder of the monomer for the polymer matrix is added to the kettle. In yet another preferred embodiment of the present invention, the reaction vessel is charged with water, and optionally surfactants and other polymerization adjuvants and optionally a polymer seed, then a part of the monomers for the polymer matrix is added to the kettle, then the dispersed non-pigment inorganic particles are added to the kettle, and finally the remainder of the monomer for the polymer matrix is added to the kettle. The polymerization may be run as a shot process, or by using multiple shots, or by continuously feeding in the monomer over time. The monomer may be added neat or emulsified in water with appropriate surfactants. For the process to be considered acceptable herein it must be capable of being effected at a final volume solids level of 40 vol % or higher, preferably at 45 vol %, with less than 1.0% by weight, based on the weight of total solids, of grit formation.

In a preferred embodiment of the present invention, the second polymer includes at least one sulfur acid-functional monomer. Examples of suitable sulfur acid-functional monomers include sulfoethyl (meth)acrylate, sulfopropyl (meth)acrylate, styrene sulfonic acid, vinyl sulfonic acid, and 2-(meth)acrylamido-2-methyl propanesulfonic acid, and salts thereof. Preferably the sulfur acid-functional monomer is styrene sulfonic acid or its salt. The sulfur acid-functional monomer may be present at a level of from 0.1% to 20% by weight of the monomers used to make the second polymer containing the sulfur acid-functional monomer, preferably from 0.25% to 10%, more preferably from 0.25% to 5%, most preferably from 0.5% to 2%. If the second polymer contains more than one polymer phase, then the sulfur acid-functional monomer may be present in just some or in all of the polymer phases. If the second polymer contains more than one polymer phase, it is preferable that the sulfur acid-functional monomer is present in the first polymer stage to be polymerized.

Polymerization of the monomers for the second polymer is effected by addition of a polymerization initiator. The polymerization initiator may be added to the kettle prior to the monomer addition, or concurrent with the monomer addition, after the monomer addition, or as a combination of these. Suitable polymerization initiators are those polymerization initiators that thermally decompose at the polymerization temperature to generate free radicals, including both water-soluble and water-insoluble species. Polymerization initiators may be used alone, and alternatively, as the oxidizing component of a redox system, which also includes a reducing component, such as an acid, and an alkali metal sulfite.

Suitable levels of initiator and the optional reducing component include proportions of from 0.001% to 5% each, based on the weight of the monomers in the monomer mixture to be polymerized. Accelerators such as chloride and sulfate salts of cobalt, iron, nickel, and copper are generally used in small amounts.

Chain transfer agents are optionally added to the aqueous reaction medium to control molecular weight of the second polymer. Examples of chain transfer agents include mercaptans, polymercaptans, and polyhalogen compounds. Examples of suitable chain transfer agents include alkyl mercaptans, such as ethyl mercaptan, n-propyl mercaptan, n-butyl mercaptan, isobutyl mercaptan, t-amyl mercaptan, n-hexyl mercaptan, cyclohexyl mercaptan, n-octyl mercaptan, n-decyl mercaptan, n-dodecyl mercaptan; 3-mercaptoproprionic acid; 2-hydroxyethyl mercaptan; alcohols, such as isopropanol, isobutanol, lauryl alcohol, and t-octyl alcohol; and halogenated compounds, such as carbon tetrachloride, tetrachloroethylene, and trichlorobromoethane. Generally from 0 to 10% chain transfer agent, by weight based on the weight of the monomer, is used to prepare the second polymer. Other techniques for controlling molecular weight, known in the art, include selecting the ratio of the initiator to total monomer amount.

Catalyst and/or chain transfer agent are optionally dissolved or dispersed in separate or the same fluid medium, and gradually added to the polymerization vessel. Monomer, neat, dissolved, or dispersed in a fluid medium, is optionally added simultaneously with the catalyst and/or the chain transfer agent.

The emulsion polymerization reaction medium typically contains surfactant to stabilize the growing second polymer-encapsulated particles during polymerization and to discourage aggregation of the polymer-encapsulated non-pigment inorganic particles in the resulting aqueous dispersion. One or more surfactants, including anionic and nonionic surfactants, and mixtures thereof, are commonly used. Many examples of surfactants suitable for emulsion polymerization are given in McCutcheon's Detergents and Emulsifiers (MC Publishing Co. Glen Rock, NF), published annually. Other types of stabilizing agents, such as protective colloids, are optionally used. However, it is preferred that the amount and type of stabilizing surfactant or other type of stabilizing agent employed during the polymerization reaction be selected so that residual stabilizing agent in the resulting aqueous dispersion does not significantly interfere with the properties of the aqueous dispersion, the properties of compositions including the aqueous dispersion, or articles prepared from the aqueous dispersion.

Suitable anionic surfactants include, for example, alkali fatty alcohol sulfates, such as sodium lauryl sulfate; arylalkyl sulfonates, such as potassium isopropylbenzene sulfonate; alkali alkyl sulfosuccinates, such as sodium octyl sulfosuccinate; and alkali arylalkylpolyethoxyethanol sulfates or sulfonates, such as sodium octyl phenoxypolyethoxyethyl sulfate, having 1 to 5 oxyethylene units.

Suitable nonionic surfactants include, for example, alkyl phenoxypolyethoxy ethanols having alkyl groups of from 7 to 18 carbon atoms and from 6 to 60 oxyethylene units, such as, for example, heptyl phenoxypolyethoxyethanols; ethylene oxide derivatives of long chained carboxylic acids, such as lauric acid, myristic acid, palmitic acid, oleic acid, or mixtures of acids, such as those found in tall oil, containing from 6 to 60 oxyethylene units; ethylene oxide condensates of long chained alcohols such as octyl, decyl, lauryl, or cetyl alcohols, containing from 6 to 60 oxyethylene units; and block copolymers of ethylene oxide sections combined with one or more hydrophobic propylene oxide sections. High molecular weight polymers, such as hydroxyethyl cellulose, methyl cellulose, and polyvinyl alcohol, are also usable.

In a preferred embodiment of the present invention the dispersed non-pigment inorganic particles are further stabilized with certain surfactants prior to the introduction of any monomers used to make the second polymer. These surfactants include the family of sulfosuccinic acid esters of the formula R—OC(O)CH₂CH(SO₃H)C(O)OR′, where R and R′ may be alkyl, aryl, allyl, vinyl, styrenyl, or (meth)acryl, or H, and where R and R′ may be the same or different, with the exception that R and R′ may not both be H. Preferably, R is C₆ to C₁₆ alkyl and R′ is allyl. It has been discovered that use of such surfactants in the manner specified allows the emulsion polymerization to be run with much lower gel levels than result when no surfactant is used, or when other surfactants are used.

After the emulsion polymerization is complete, the polymer encapsulated non-pigment inorganic particles may be provided as an aqueous dispersion, or alternately they may be provided as a solid in the form of a powder or pellet. The polymer encapsulated non-pigment inorganic particles may be removed from the aqueous medium of the emulsion polymerization by any appropriate technique including, for example, evaporative drying, spray drying, filtration, centrifugation, or coagulation. When the polymer-encapsulated non-pigment inorganic particles are provided as a solid, it is preferred that the Tg of the second polymer, or the Tg of the outermost phase of the second polymer in the case where the second polymer contains multiple phases, is above the temperature at which the polymer-encapsulated non-pigment inorganic particles will be stored, transported, and optionally processed prior to final application.

The composition of the present invention including the non-pigment inorganic particle encapsulated in second polymer of the invention is typically a coating or a plastic. Optionally, the coating or plastic also includes one or more of secondary extender particles, pigment particles, and third polymers.

The binder of the coating or plastic of the present invention is the continuous medium containing the polymer-encapsulated non-pigment inorganic particles. The binder may consist solely of the second polymer which encapsulates the non-pigment inorganic particles, or it may be a mixture of the encapsulating second polymer and one or more third polymers. Both the second polymer and third polymer are independently, alternatively a homopolymer, a copolymer, an interpenetrating network polymer, and a blend of two or more polymers or copolymers. Suitable third polymers include acrylic (co)polymers, vinyl acetate polymers, vinyl/acrylic copolymers, styrene/acrylic copolymers, polyurethanes, polyureas, polyepoxides, polyvinyl chlorides, ethylene/vinyl acetate polymers, styrene/butadiene polymers, polyester polymers, polyethers, and the like, and mixtures thereof.

In one preferred embodiment the binder may be a mixture of a polymer and a pre-polymeric material. The polymer-encapsulated non-pigment inorganic particles are alternatively provided in a liquid medium such as an organic solvent or water, or a mixture of organic solvents and water, or are provided as a solid, such as a powder. The optional third polymer is alternatively provided in a liquid medium such as a solution polymer, an emulsion polymer, or a suspension polymer, or is provided as a solid, such as a polymer powder or an extrusion polymer. Either or both the second polymer of the polymer-encapsulated non-pigment inorganic particle or the optional third polymer may contain reactive groups, which upon formation of a coating film or finished plastic part or afterwards, crosslink either with themselves or with externally added crosslinkers to provide a crosslinked binder. Examples of pre-polymeric materials are ethylenically unsaturated monomers and oligomers, and two-part crosslinking systems such as compositions containing isocyanate groups and alcohol groups. Conventional crosslinking agents such as, for example, polyaziridine, polyisocyanate, polycarbodiimide, polyepoxide, polyaminoplast, polyalkoxysilane, polyoxazoline, polyamine, and a polyvalent metal compound can be used as externally added crosslinkers. Typically, from 0 to 25 wt % of the crosslinking agent is used, based on the dry weight of the polymer.

The polymers which form the binder typically have glass transition temperatures in the range of from −60° C. to 150° C., as calculated by the Fox equation [Bulletin of the American Physical Society 1, 3 Page 123 (1956)]. The coating or plastic composition optionally contains coalescents or plasticizers to provide the polymers with effective film formation temperatures at or below the temperature at which the coating is applied or cured, or the plastic part is formed. The level of optional coalescent is typically in the range of from 0 to 40 wt %, based on the weight of the polymer solids.

The coating or plastic of this invention optionally contains secondary pigment particles. The secondary pigment particles have an index of refraction less than the index of refraction of the polymer matrix. Secondary pigment particles include pigment particles containing air voids, such as polymer particles containing air voids. The air void is characterized as having an index of refraction close to or equal to 1. Secondary pigment particles including microsphere pigments such as polymer particles containing one or more voids and vesiculated polymer particles are well known in the art.

The coating or plastic of this invention contains from 1 to 50 volume % of polymer-encapsulated non-pigment particles, preferably from 3 to 30 volume %, and more preferably from 5 to 20 volume %, based on the total volume of the coating or plastic. The coating or plastic contains from 10 to 99 volume % second and third polymer, preferably from 20 to 97 volume %, and more preferably from 25 to 80 volume %, based on the total volume of the coating or plastic. The coating or plastic contains from 0 to 70 volume % nonencapsulated extender particles, preferably from 0 to 65 volume %, and more preferably from 0 to 60 volume %, based on the total volume of the coating or plastic. The coating or plastic contains from 0 to 20 volume % pigment particles, preferably from 0 to 17 volume %, and more preferably from 0 to 15 volume %, based on the total volume of the coating or plastic.

The coating composition of the present invention optionally may also include other materials commonly found in coatings such as nonencapsulated extenders, other polymers, hollow sphere pigments, solvents, coalescents, wetting agents, defoamers, rheology modifiers, crosslinkers, dyes, pearlescents, adhesion promoters, dispersants, leveling agents, optical brighteners, ultraviolet stabilizers, preservatives, biocides, and antioxidants.

Examples of “coatings” herein include inks, paper coatings; architectural coatings, such as interior and exterior house paints, wood coatings and metal coatings; coatings for leather; coatings and saturants for textiles and nonwovens; adhesives; powder coatings; and traffic paints such as those paints used to mark roads, pavements, and runways. Liquid coatings may be water or solvent based. When the coating is a powder coating, it is preferred that the Tg of the polymeric matrix, or the Tg of the outer most phase of the polymeric matrix in the case where the polymeric matrix contains multiple phases, is above the temperature at which the coating will be stored, transported, and optionally processed prior to final application. When the coating is a solvent-based coating, it is preferred that the second polymer of the polymer-encapsulated non-pigment particles is not substantially soluble in the solvent or mixture of solvents utilized in the coating.

The plastic of the present invention optionally may also include other materials commonly found in plastics such as pigment particles, extenders, other polymers, hollow sphere pigments, plasticizers, flow agents, and crosslinkers. “Plastics” herein includes solid or flexible materials in the form of objects, films, etc.

1. A non-pigment particle encapsulated in polymer; said particle comprising: (a) a non-pigment inorganic particle having an average particle diameter of from 0.005 to 5 microns and an index of refraction of less than 1.8; (b) from 0.1 to 25 wt % of a water-soluble sulfur acid-functional first polymer, based on the weight of the non-pigment inorganic particle; and (c) from 10 to 200 wt % of a second polymer that at least partially encapsulates the non-pigment inorganic particle, based on the weight of the non-pigment inorganic particle.

2. The non-pigment particle encapsulated in polymer of claim 1 wherein said sulfur acid-functional first polymer comprises at least two amine moieties.

3. The non-pigment particle encapsulated in polymer of claim 1 wherein said second polymer comprises, as a copolymerized unit, at least one acid-functional monomer.

4. The non-pigment particle encapsulated in polymer of claim 1 wherein said second polymer comprises at least two phases, wherein one polymer phase has a Tg greater than or equal to 40° C. and one polymer phase has a Tg less than or equal to 25° C.

5. The non-pigment particle encapsulated in polymer of claim 1 wherein the non-pigment inorganic particle comprises alumina or silica.

6. The non-pigment particle encapsulated in polymer of claim 3 wherein said acid-functional monomer is a sulfur acid-functional monomer.

7. A process for forming a non-pigment particle encapsulated in polymer comprising:
(a) dispersing a non-pigment inorganic particle having an average particle diameter of from 0.005 to 5 microns and an index of refraction of less than 1.8 in a medium with from 0.1 to 25 wt % of a water-soluble sulfur acid-functional first polymer, based on the weight of said non-pigment inorganic particle; and
(b) performing an emulsion polymerization in the presence of said dispersed non-pigment inorganic particle to provide from 10% to 200 wt % of a second polymer that at least partially encapsulates said dispersed non-pigment inorganic particle, based on the weight of said non-pigment inorganic particle.

8. The process of claim 7 wherein said sulfur acid-functional first polymer comprises at least two amine moieties.

9. The process of claim 7 wherein said second polymer comprises, as a copolymerized unit, at least one acid-functional monomer.

10. The process of claim 7 wherein said second polymer comprises at least two phases, wherein the first polymer phase formed has a Tg greater than or equal to 40° C. and one polymer phase has a Tg less than or equal to 25° C.
